(19) United States
(12) Patent Application Publication
(10) Pub. No.: US 2025/0131771 A1
(43) Pub. Date: Apr. 24, 2025

(54) ELECTRONIC DEVICES AND METHODS FOR IDENTIFYING GESTURES ASSOCIATED WITH A TARGET OBJECT

(71) Applicant: Samsung Electronics Co., Ltd., Suwon-si (KR)

(72) Inventors: Saurav GAJBHIYE, Noida (U.P.) (IN); Prashant SRIVASTAVA, Noida (U.P.) (IN)

(21) Appl. No.: 18/794,363

(22) Filed: Aug. 5, 2024

Related U.S. Application Data
(63) Continuation of application No. PCT/KR2024/008246, filed on Jun. 14, 2024.

(30) Foreign Application Priority Data
Oct. 23, 2023 (IN) 202311072397

(51) Int. Cl. G06V 40/20; G06T 7/13; G06T 7/20; G06V 10/25; G06V 10/40

(52) U.S. Cl. CPC G06V 40/20; G06T 7/13; G06T 7/20; G06V 10/25; G06V 10/40; G06V 2201/07

(57) ABSTRACT

A method for identifying a gesture associated with a target object may include receiving an image associated with the target object; identifying a region of interest (ROI) within the image associated with the target object; determining one or more feature vectors associated with the target object based on the ROI; generating a traversal path estimate based on the image and the ROI, the traversal path estimate being indicative of a region of movement of the target object; determining, based on the one or more feature vectors and the traversal path estimate, whether the gesture associated with the target object is one of a false gesture or a real gesture; and triggering a response based on the gesture being determined to be a false gesture or a real gesture.

### CROSS-RFERENCE TO RELATED APPLICATIONS

This application is a continuation of International Application No. PCT/KR2024/008246 designating the United States, filed on Jun. 14, 2024, in the Korean Intellectual Property Receiving Office and claiming priority to Indian Patent Application No. 202311072397, filed on Oct. 23, 2023, in the Indian Patent Office, the disclosures of each of which are incorporated by reference herein in their entireties.

### BACKGROUND

### Field

The disclosure relates to gesture identification systems, and, for example, to systems and methods for identifying accidental-false and deliberate-false gestures associated with a target object.

### Description of Related Art

In recent years, gesture technology has gained significant attention and adoption across various applications. Gesture recognition technology is widely used in day-to-day living, such as in smart devices, connected devices, and Internet of Things (IoT) based devices. Gesture-based devices enable hands-free interaction with the devices and enhance user experiences in human-computer interactions associated with recreation, gaming, virtual reality, and the like. Increased adoption of smart devices has simulated the growth of gesture recognition-based techniques.

Some applications in which gesture recognition-based techniques are employed include smart televisions, augmented reality devices, virtual reality devices, automotive systems, gaming consoles, and the like. In addition, there has been increased adoption of touchless technology in the aftermath of the COVID-19 pandemic. The related gesture technologies allow a user to make use of gestures to send commands to a connected electronic device. High resolution cameras may be used to track the hand movements and detect gestures.

However, an issue within related gesture recognition technologies is that any user may perform hand gestures to control various functions of the devices. The related gesture recognition technologies fail to reliably distinguish between real gestures and false gestures (e.g., unintentional movements or fraudulent attempts). Further, if gesture function is performed too close or too far from the cameras, the gesture may not be sensed properly. In a case in which the hand is too close to the body or face of the user, the gesture may not be recognized. Additionally, there is a risk of false detection when a user may move their hand within the line of sight of the cameras in a similar manner to a gesture. Moreover, with multiple users within the line of sight of the cameras, gestures from another user may be given preference over a main user.

### SUMMARY

This summary is provided to introduce a selection of concepts, in a simplified format, that are further described in the disclosure. This summary is neither intended to identify key or essential inventive concepts of the disclosure nor is it intended to determine the scope of the disclosure.

According to an embodiment of the present disclosure, a method for identifying a gesture associated with a target object may include obtaining an image associated with the target object.; According to an embodiment of the present disclosure, the method for identifying a gesture associated with a target object may include identifying a region of interest (ROI) within the image, the ROI being associated with the target object.; According to an embodiment of the present disclosure, the method for identifying a gesture associated with a target object may include obtaining one or more feature vectors associated with the target object based on the identified ROI.; According to an embodiment of the present disclosure, the method for identifying a gesture associated with a target object may include obtaining a traversal path estimate based on the obtained image and the identified ROI, the traversal path estimate being indicative of a region of movement of the target object.; According to an embodiment of the present disclosure, the method for identifying a gesture associated with a target object may include identifying, based on the one or more feature vectors and the obtained traversal path estimate, the gesture associated with the target object to be one of a false gesture or a real gesture.

According to an embodiment of the present disclosure, an electronic device for identifying a gesture associated with a target object may include a memory configured to store a plurality of modules in the form of programmable instructions; at least one. According to an embodiment of the present disclosure, an electronic device for identifying a gesture associated with a target object may include at least one processor, comprising processing circuitry, communicatively coupled to the memory, the at least one processor. According to an embodiment of the present disclosure, at least one processor may be configured to obtain (e.g., receive) an image associated with the target object.; According to an embodiment of the present disclosure, at least one processor may be configured to identify a region of interest (ROI) within the image, the ROI being associated with the target object.; According to an embodiment of the present disclosure, at least one processor may be configured to obtain one or more feature vectors associated with the target object based on the identified ROI.; According to an embodiment of the present disclosure, at least one processor may be configured to obtain a traversal path estimate based on the obtained image and the identified ROI, the traversal path estimate being indicative of a region of movement of the target object.; According to an embodiment of the present disclosure, at least one processor may be configured to identify (e.g., determine), based on the one or more feature vectors and the obtained traversal path estimate, the gesture associated with the target object to be one of a false gesture or a real gesture.

One embodiment provides a machine readable medium containing instructions. The instructions, when executed by at least one processor, may cause the at least one processor to perform the method corresponding.

To further clarify advantages and features of the disclosure, a more particular description will be provided with reference to specific embodiments thereof, which are illustrated in the appended drawings. It is appreciated that these drawings depict only example embodiments of the disclosure and are therefore not to be considered limiting in scope. The disclosure will be described and explained with additional specificity and detail with the accompanying drawings.

### BRIEF DESCRIPTION OF THE DRAWINGS

These and other features, aspects, and advantages of an embodiment of the present disclosure will be more apparent from the following detailed description, taken in conjunction with the accompanying drawings (in which like characters represent like parts throughout the drawings), in which:

FIG. 1 illustrates an overview of an example environment including a system, a user device, and one or more users, according to an embodiment of the present disclosure;

FIG. 2A is a detailed block diagram of an example system for identifying a gesture associated with a target object, according to an embodiment of the present disclosure;

FIGS. 2B, 2C, 2D, and 2E are block diagrams depicting sub-modules of an example localization module, an example feature vector module, an example object path module, and an example determination module, respectively, according to an embodiment of the present disclosure;

FIG. 3 illustrates an example operational flow among a plurality of modules and corresponding sub-modules, according to an embodiment of the present disclosure;

FIG. 4A illustrates example steps involved in determination of distance between feature points associated with a target object, according to an embodiment of the present disclosure;

FIG. 4B illustrates example steps involved in determination of feature vectors associated with a target object, according to an embodiment of the present disclosure;

FIG. 4C illustrates an example grid map formed of the plurality of grids, according to an embodiment of the present disclosure;

FIG. 4D illustrates an example adjustment of a grid map, according to an embodiment of the present disclosure;

FIG. 4E illustrates an example generated traversal path estimate, according to an embodiment of the present disclosure;

FIGS. 5A, 5B, 5C, 5D, and 5E illustrate example process flows for identifying a gesture associated with a target object, according to an embodiment of the present disclosure; and

FIGS. 6A, 6B, 6C, 6D, 6E, 6F, 6G, 6H, and 6I illustrate various usage scenarios of an example system for identifying a gesture associated with a target object, according to an embodiment of the present disclosure.

Further, skilled artisans will appreciate that elements in the drawings are illustrated for simplicity and are not necessarily drawn to scale. For example, flow charts may illustrate a method in terms of example steps involved to improve understanding of aspects of the disclosure. Furthermore, in terms of the construction of the device, one or more components of the device may have been represented in the drawings by conventional symbols, and the drawings may show only those specific details that are pertinent to understanding an embodiment of the disclosure so as not to obscure the drawings with details that will be readily apparent to those having the benefit of the description herein.

### DETAILED DESCRIPTION

For the purpose of promoting an understanding of the principles of the disclosure, reference will now be made to an embodiment and specific language will be used to describe the same. It will nevertheless be understood that no limitation of the scope of the disclosure is thereby intended, and that alterations and further modifications to the illustrated examples, and such further applications of the principles of the disclosure as illustrated therein are contemplated.

It will be understood by those skilled in the art that the foregoing general description and the following detailed description provided by way of explanation and are not intended to be restrictive of the disclosure.

Reference throughout the disclosure to “an aspect”, “another aspect” or similar language may refer, for example, to a particular feature, structure, or characteristic described in connection with the embodiment being included in an embodiment of the present disclosure. Thus, appearances of the phrase “in an embodiment”, “in another embodiment” and similar language throughout this specification may refer to the same or different embodiments.

The terms “comprise”, “comprising”, “include”, “including”, or variations thereof, refer to, for example, a non-exclusive inclusion, such that a process or method that includes a list of steps does not include only those steps but may include other steps not expressly listed or inherent to such process or method. Similarly, one or more devices or sub-systems or elements or structures or components proceeded by “comprises . . . a” or “includes . . . a” does not, without additional constraints, preclude the existence of other devices or other sub-systems or other elements or other structures or other components or additional devices or additional sub-systems or additional elements or additional structures or additional components.

The terms “multi-party conversation”, “human-to-human conversation”, and “conversation” may be used interchangeably throughout the description. The terms “user device”, “device”, and “electronic device” along with their inherent variations may be used interchangeably throughout the description.

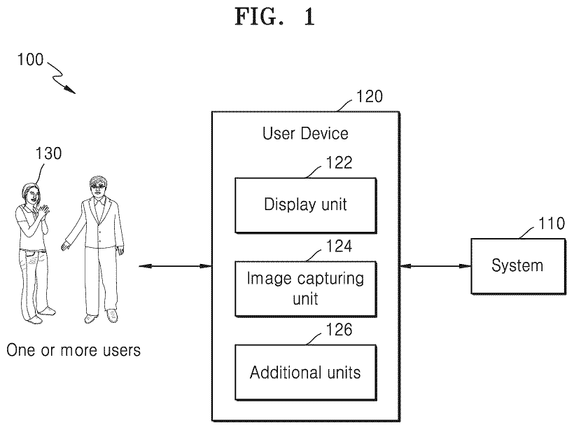

FIG. 1 illustrates an overview of an example environment 100 including a system 110 and a user device 120 associated with one or more users 130, according to an embodiment of the present disclosure. The one or more users 130 may include a main user (interchangeably referred to as target object) and additional users. The one or more users 130 may interact with the user device 120 based on gesture techniques, in that, hand gestures may be used by the one or more users 130 to send a command to the user device 120 for performing an action.

In an embodiment, the user device 120 may include, but is not limited to, a smart television, a mobile phone, laptops, Augmented Reality (AR) headsets, Virtual Reality (VR) headsets, a smart fridge, and other smart devices integrated with cars, gaming consoles, gym equipment, and the like. In an embodiment, the user device 120 may include a display unit 122 (e.g., including a display) which may be a graphical user interface (GUI) that enables the one or more users 130 to interact with the device 120 and view information thereon. In an embodiment, the user device 120 may include an image capturing unit 124 configured to capture images of the one or more users 130, for instance, when the one or more users 130 may perform a gesture via their hands. In an embodiment, the image capturing unit 124 may be a camera. In an embodiment, the user device 120 may further include additional units 126, such as, a user interaction unit, a memory unit, an operating system, applications, and input/output interfaces. For the sake of brevity, the architecture and standard operations of the additional units 126 are not discussed in detail.

As depicted, the system 110 may be in communication with the user device 120. The system 110 may obtain the image captured by the image capturing unit 124 indicative of a gesture being performed by the one or more users 130 and process the image to identify whether the gestures are false gestures or real gestures. In an embodiment, the system 110 may be a standalone entity located at a remote location and connected to the user device 120 via any suitable network. For example, the system 110 may be implemented on a physical server (not shown in FIG. 1) or in a cloud-based architecture and communicably coupled to the user device 120. In an embodiment, the system 110 may be integrated within the user device 120. In an embodiment, the system 110 may be implemented in a distributed manner, in that, one or more components of the system 110 may be implemented within the user device 120, while one or more components of the system 110 may be implemented within a cloud-based server or a physical server.

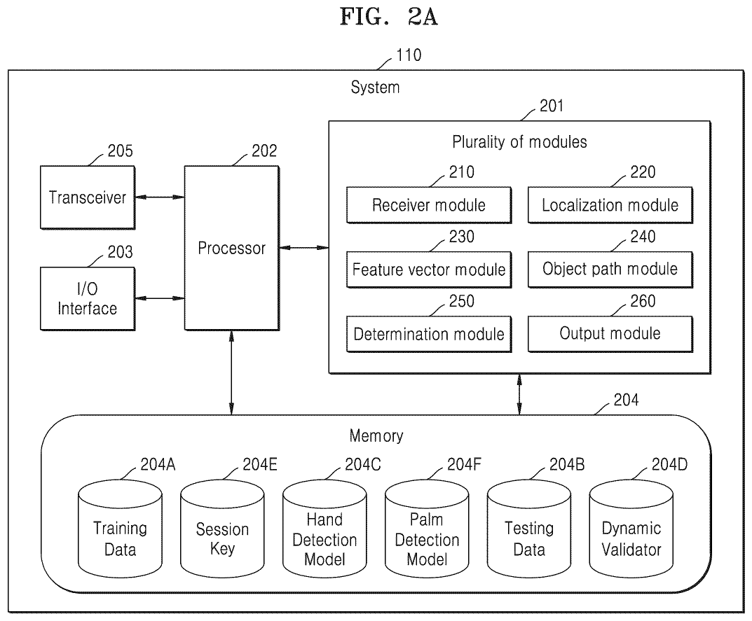

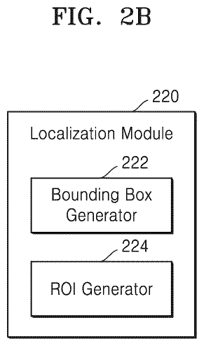

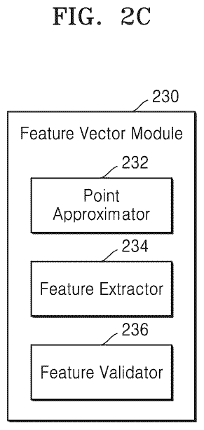

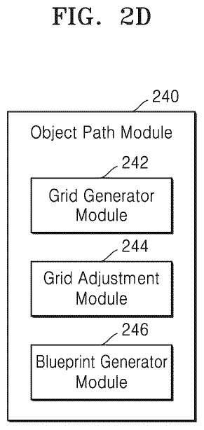

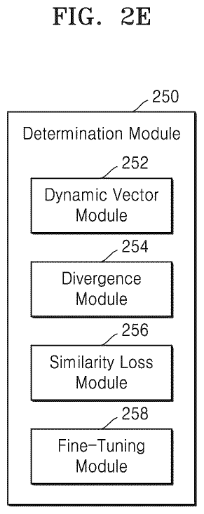

The system 110 may be configured to accurately and efficiently categorize gestures being performed by the one or more users 130 as real or false gestures. The system 110 may be configured to perform operations and achieve technical advantages by performing one or more operations as explained in detail at least with reference to FIGS. 2A to 4E.

Reference is made to FIG. 2A which is a detailed block diagram of an example system 110, according to an embodiment of the present disclosure. The system 110 may be configured to receive and process an image to be captured by the user device 120. The system 110 may include a plurality of modules 201, a processor 202, an Input/Output (I/O) interface 203, a memory 204, and a transceiver 205. Further, in an embodiment in which the system 110 is implemented as a standalone entity at a server/cloud architecture, the system 110 may be in communication with multiple user devices to receive image(s) captured from each of the multiple user devices, and the details provided below with respect to the system 110 and the user device 120 are applicable for the system 110 and the multiple user devices as well.

In an example embodiment, the processor 202 may be operatively coupled to each of the I/O interface 203, the plurality of modules 201, the transceiver 205, and the memory 204. The processor 202 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. In an embodiment, the processor 202 may include a graphical processing unit (GPU) and/or an AI Engine (AIE). In an embodiment, the processor 202 may include at least one data processor for executing processes in a virtual storage area network. The processor 202 may include specialized processing units such as integrated system (bus) controllers, memory management control units, floating point units, graphics processing units, digital signal processing units, and the like. In an embodiment, the processor 202 may include a central processing unit (CPU), a graphics processing unit (GPU), or both. The processor 202 may be one or more general processors, digital signal processors, application-specific integrated circuits, field-programmable gate arrays, servers, networks, digital circuits, analog circuits, combinations thereof, or other now known or later developed devices for analyzing and processing data. The processor 202 may execute a software program, such as code generated manually (i.e., programmed) to perform a desired operation.

The processor 202 may be disposed in communication with one or more input/output (I/O) devices via the I/O interface 203. In an embodiment, the processor 202 may communicate with the user device 120 using the I/O interface 203. In an embodiment, the I/O interface may be implemented within the user device 120. The I/O interface 203 may employ communication code-division multiple access (CDMA), high-speed packet access (HSPA+), global system for mobile communications (GSM), long-term evolution (LTE), WiMax, or the like, etc.

Using the I/O interface 203, the system 110 may communicate with one or more I/O devices, for example, user devices being used to capture images. For example, the input device may include an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, and the like.

The processor 202 may be disposed in communication with a communication network via a network interface. In an embodiment, the network interface may be the I/O interface 203. The network interface may connect to the communication network to enable connection of the system 110 with the user device 120 and/or outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 110 may communicate with other devices.

In an embodiment, the memory 204 may be communicatively coupled to the processor 202. The memory 204 may be configured to store data, including instructions executable by the processor 202. In an embodiment, the memory 204 may be provided within the user device 120. In an embodiment, the memory 204 may be provided within the system 110 being remote from the user device 120. In an embodiment, the memory 204 may communicate with the processor 202 via a bus within the system 110. In an embodiment, the memory 204 may be located remote from the processor 202, and may be in communication with the processor 202 via a network. The memory 204 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In an example embodiment, the memory 204 may include a cache or random-access memory for the processor 202. In an embodiment, the memory 204 is separate from the processor 202, such as a cache memory of a processor, the system memory, or other memory. The memory 204 may be an external storage device or database for storing data. The memory 204 may be operable to store instructions executable by the processor 202. The functions, acts or tasks illustrated in the figures or described herein may be performed by the programmed processor 202 for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

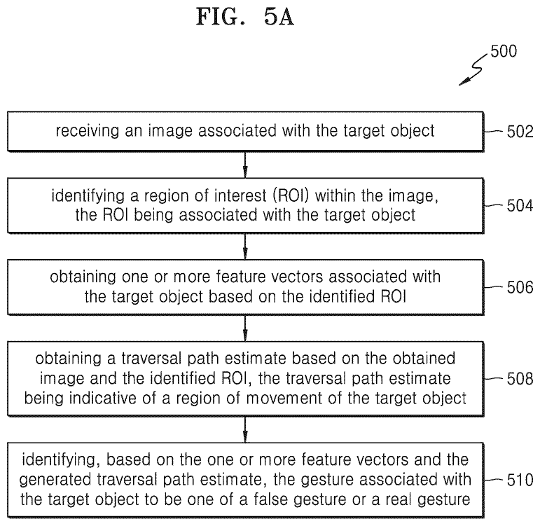

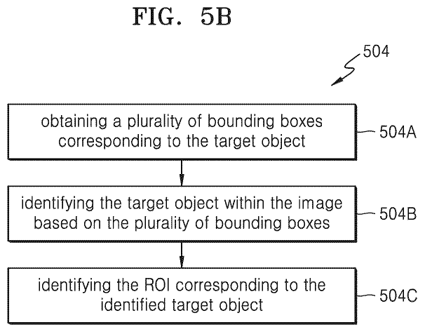

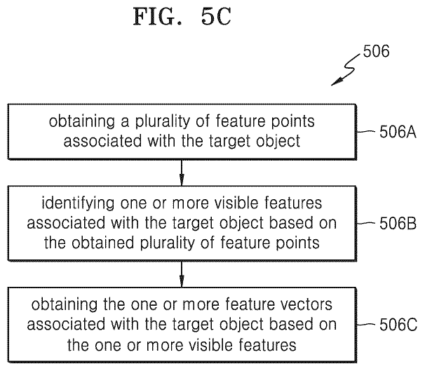

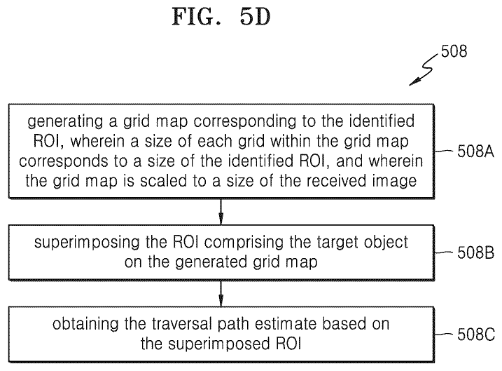

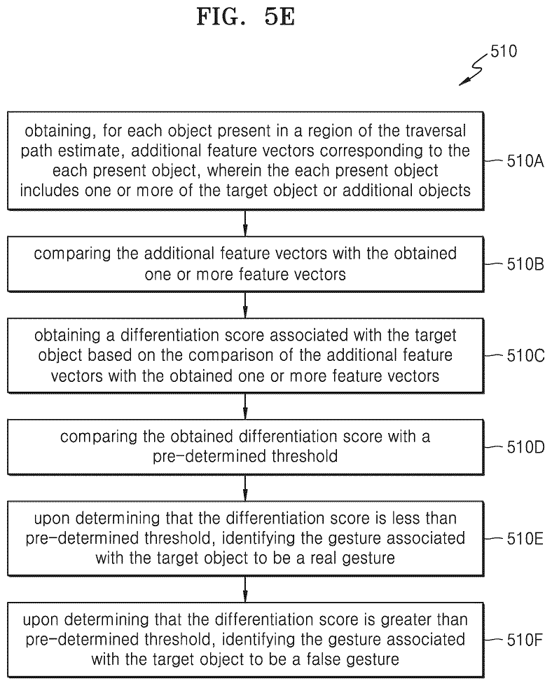

In an embodiment, the plurality of modules 201 may be included within the memory 204. The memory 204 may further include a database to store data. The plurality of modules 201 may include a set of instructions that may be executed to cause the system 110, in an example, the processor 202 of the system 110, to perform any one or more of the methods/processes disclosed herein. The plurality of modules 201 may be configured to perform steps of the present disclosure using the data stored in the database. For instance, the plurality of modules 201 may be configured to perform the steps disclosed in FIGS. 5A-5E. In an embodiment, each of the plurality of modules 201 may be a hardware unit which may be outside the memory 204. Further, the memory 204 may include an operating system for performing one or more tasks of the system 110, as performed by a generic operating system.

The memory 204 may also include one or more databases including training data 204A, testing data 204B, hand detection model 204C, and dynamic validator 204D. The memory 204 may further include session key 204E and palm detection model 204F. The one or more databases may be accessed by the processor 202 and/or the modules 201 so as to perform the operations as detailed with respect to FIGS. 2A-4E and 5A-5E.

The transceiver 205 may be configured to receive and/or transmit signals to and from the user device 120. In an embodiment, the database may be configured to store the information as required by the plurality of modules 201 and the processor 202 to perform one or more functions for processing and images and analyzing gestures.

In an embodiment, the I/O interface 203 may enable input and output to and from the system 110 using suitable devices such as, but not limited to, display, keyboard, mouse, touch screen, microphone, speaker and so forth.

The plurality of modules 201 may include, but is not limited to, a receiver module 210, a localization module 220, a feature vector module 230, an object path module 240, a determination module 250, and an output module 260. Each of the plurality of modules 201 may further include sub-modules, as detailed further below. The plurality of modules 201 may be implemented by way of suitable hardware and/or software applications.

In an embodiment, at least one of the plurality of modules 201 may use an AI model. The AI model may also be used for enhancing the suggesting and recommending configurations for every subsequent image capture event. A function associated with AI may be performed through, for example, the non-volatile memory, the volatile memory, and the processor 202.

The processor 202 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors may control the processing of the input data in accordance with a predefined operating rule stored in the non-volatile memory or may employ a suitable artificial intelligence (AI) model executed from a server or a local memory module.

The AI model may include a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, active learning and reinforcement learning. The processor 202 may perform pre-processing operations on the data to convert it into a form appropriate for use as an input for the artificial intelligence (AI) model.

Reasoning prediction is a technique of logically reasoning and predicting by determining information and includes, e.g., knowledge-based reasoning, optimization prediction, preference-based planning, or recommendation.

Further, the present disclosure contemplates a non-transitory computer-readable medium that includes instructions or receives and executes instructions responsive to a propagated signal. Further, the instructions may be transmitted or received over the network via a communication port or interface or using a bus (not shown). The communication port or interface may be a part of the processor 202 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 110 may be physical or may be established wirelessly. The network may alternatively be directly connected to a bus. For the sake of brevity, the architecture and standard operations of the memory 204, the processor 202, the transceiver 205, and the I/O interface 203 are not discussed in detail.

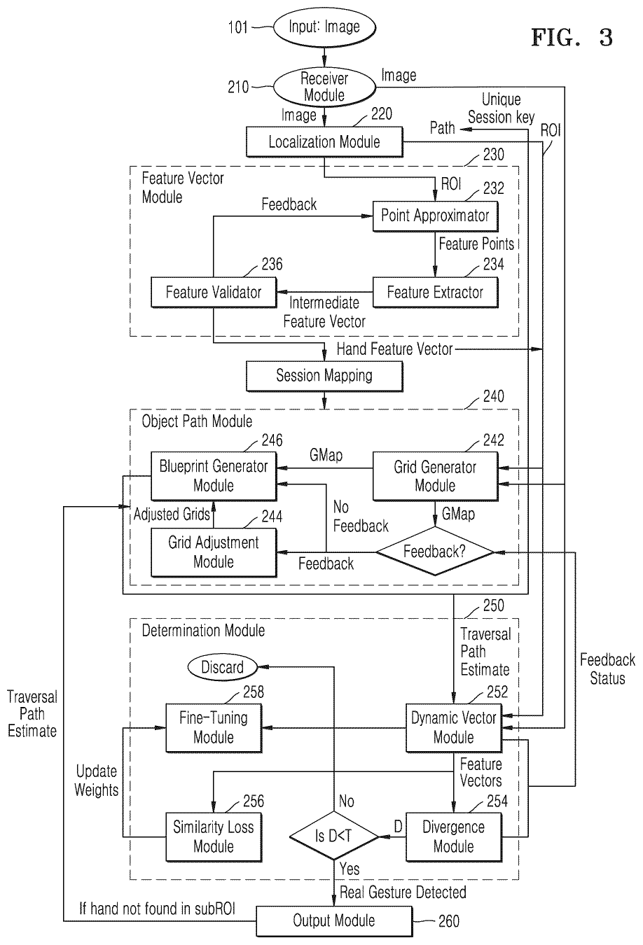

FIG. 2B, 2C, 2D, and 2E are block diagrams depicting example sub-modules of the localization module 220, the feature vector module 230, the object path module 240, and the determination module 250. Further, FIG. 3 illustrates an example operational flow 300 among the plurality of modules 201 and the corresponding sub-modules. Details of the present disclosure will now be described by collectively referring to FIGS. 2A, 2B, 2C, 2D, and 2E and FIG. 3.

In an embodiment, the receiver module 210 may be configured to obtain (e.g., receive) an image 101 associated with the target object, as shown in FIG. 3. The target object may be a particular user, for example one user from among the one or more users 130 in the vicinity of the user device 120. In an embodiment, the image 101 may be captured using the image capturing unit 124 (e.g., camera) associated with the user device 120. The image 101 may include the one or more users 130 in which the target object is performing a gesture, which may be a false gesture or a real gesture. As an example, the target object may be using gesture controls and pointing their hands towards the image capturing unit 124 (e.g., a web camera). The system 110 may be configured to identify whether the gesture being performed by the target object is a real gesture or a false gesture, as described in detail below. In an embodiment, the system 110 may perform the determination for each of the one or more users within the image 101.

In an embodiment, the localization module 220 may be configured to identify a region of interest (ROI) within the image 101, as shown in FIG. 3. The identified ROI is associated with the target object. For example, the identified ROI may correspond to the hand of the target object which is being used for providing gestures.

As shown in FIG. 2B, the localization module 220 may include sub-modules, namely, a bounding box generator 222 and a ROI generator 224. The bounding box generator 222 may be configured to, for example, obtian a plurality of bounding boxes corresponding to the target object. In an example, the plurality of bounding boxes may be superimposed on a hand of the target object in the received image 101.

The plurality of bounding boxes may refer to, for example, rectangular structures of varying dimensions (size, aspect ratio, etc.) being superimposed on an item within the image 101, such as the hand of the target object in the received image 101. In an embodiment, each bounding box of the plurality of bounding boxes is indicative of a position of the item, a class of the item, and a confidence score of the item. The confidence score may refer to, for example, a probability of presence of the item within the corresponding bounding box.

Further, ROI generator 224 may be configured to, for example, identify the target object within the image 101 based on the plurality of bounding boxes and identify the ROI corresponding to the detected target object. The ROI may correspond to the hand of the target object since the target object may provide the gestures via the hand. In an example, considering the image 101 including the target object, the hand of the target object may be assigned a class C_{hand}=hand with a confidence score CS_{hand}=98%, thereby indicating that the hand of the target object is present in the image 101. In an embodiment, the ROI generator 224 may be configured to identify the ROI using a Non-Maximum Suppression technique. In an embodiment, the ROI generator 224 may be configured to prune the plurality of bounding boxes and discard overlapping regions, i.e., regions having overlapped bounding boxes using Intersection over Union information (IoU). Accordingly, a location of the hand of the target object may be idntified within the image 101 by the ROI generator 224.

In an embodiment, the feature vector module 230 may be configured to, for example, obtain one or more feature vectors associated with the target object based on the identified ROI. The one or more feature vectors may correspond to the hand of the target object. As shown in FIG. 2C and FIG. 3, the feature vector module 230 may include multiple sub-modules, namely, point approximator 232, feature extractor 234, and feature validator 236.

The point approximator 232 may be configured to, for example, obtain a plurality of feature points associated with the target object based on the identified ROI. The plurality of feature points may correspond to landmarks of the hand of the target object. In an example embodiment, the plurality of feature points may include a set of 30 approximated feature points. The point approximator 232 may be configured to detect edges associated with the target object, in an example, the hand of the target object. The detection of edges may be carried out based on an edge detection model, which may lead to generation of an edge detected object. An example of the edge detection model may include Sobel Edge Detector and Prewitt Edge Detector. In an embodiment, the edge detected object may be generated based on the equation (1) below:

$$( 1 )$$

$$E\_object = ∇ H\_object = \vert H\_ ( object , x ) \vert + \vert ∇ H\_ ( object , y ) \vert = \vert H\_object ⊙ G\_x \vert + \vert {H}_{object} ⊙ {G}_{y} \vert$$

where E_{object} is the gradient of the edges detected, ∇H_{object,x} and ∇H_{object,y} are the gradient of H_{object} in x and y axes, and Gₓ and G_{y} are 3×3 Sobel kernels.

The point approximator 232 may be configured to obtain the plurality of feature points from the edge detected object based on a first trained mathematical model. In an embodiment, the first trained mathematical model may be a convolutional neural network (CNN) model including convolutional layers, pooling layers, and fully connected layers. In an embodiment, the plurality of feature points may be normalized to a width and height of the received image 101.

In an embodiment, the first trained mathematical model may be trained to estimate the plurality of feature points from the edge detected object. In order to train the first mathematical model, relevant inputs and outputs may be provided to the first mathematical model. For example, a dataset including multiple images of hands may be used. The dataset may be categorized into labelled and un-labelled states based on human feedback and hand labelling. From the dataset, a reference image (say, xₜᵣₐᵢₙ) may be provided as input to the first mathematical model and feature points corresponding to xₜᵣₐᵢₙ, i.e., (Sᵢ, 1≤i≤30) may be provided as output to the first mathematical model.

The feature extractor 234 may be configured to, for example, identify one or more visible features associated with the target object based on the generated plurality of feature points. The feature extractor 234 may be configured to obtain a set of distances among the plurality of feature points. In an embodiment, the distance between a first feature point and a second feature point from among the plurality of feature points may be determined based on a length of a line segment connecting the first feature point and the second feature point.

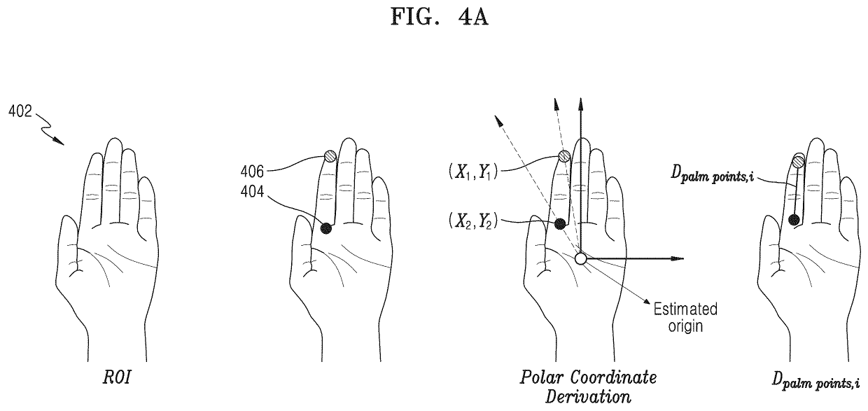

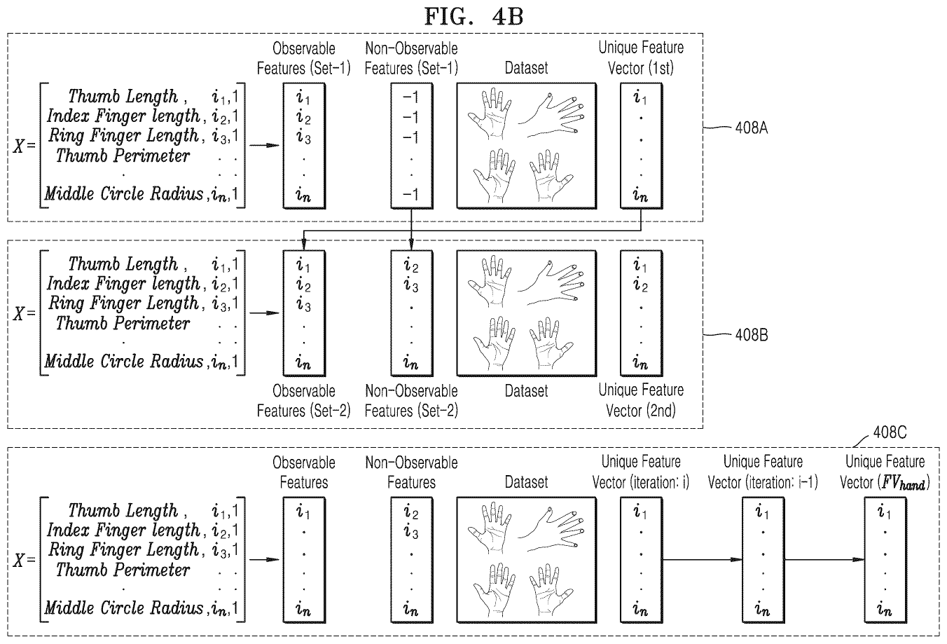

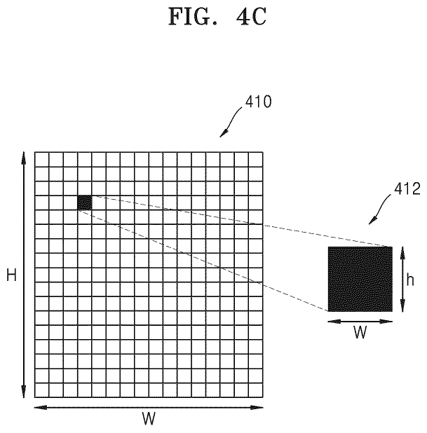

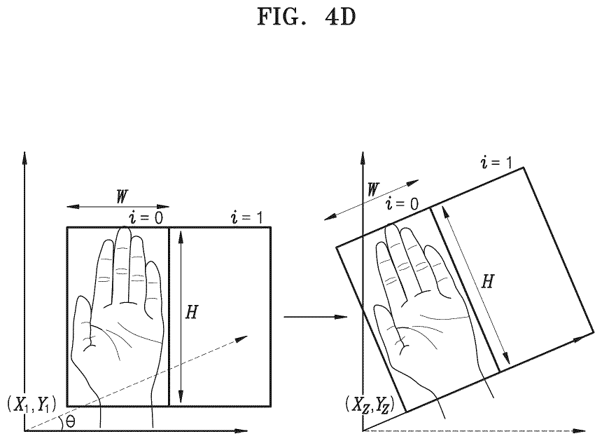

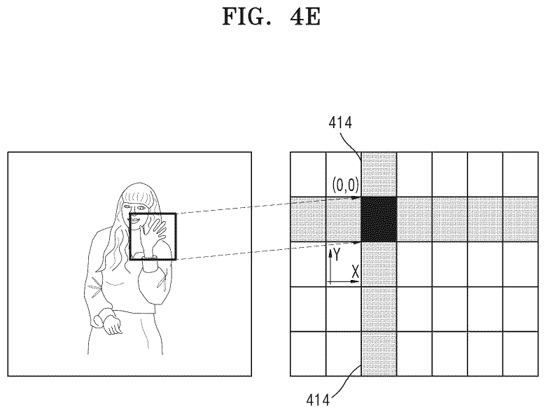

As an example, referring to FIG. 4A, considering the ROI 402 of the hand of the target object within the obtained image 101, the ROI 402 may include feature points 404, 406. A center of the hand may be considered as an origin and cartesian coordinates may be considered as polar coordinates. The distances among the plurality of feature points may be determined based on equations (2) to (5) below.

$$( {X}_{1} , {Y}_{1} ) = ( R , θ ) \qquad ( 2 )$$

$$( {X}_{2} , {Y}_{2} ) = ( S φ ) \qquad ( 3 )$$

$${D}_{palm points} , i = \begin{matrix}\sqrt{{( {X}_{2 , i} - {X}_{1 , i} )}^{2} + {( {Y}_{2 , i} - {Y}_{1 , i} )}^{2}} & ∀ 0 \leq i < 30\end{matrix} \qquad ( 4 )$$

$${D}_{palm points} , j = \begin{matrix}\sqrt{{( {R}_{j} )}^{2} + {( {S}_{j} )}^{2} - 2 {R}_{j} * {S}_{j} cos ( {θ}_{j} - {φ}_{j} )} & ∀ 0 \leq 1 < 30\end{matrix} \qquad ( 5 )$$

where:
D_{palm points, i} is the Cartesian distance for the approximated palm point ‘i’,
D_{palm points, j} is the Polar coordinate distance for the approximated palm point ‘j’,
X_{1,i} & X_{2,i} is the X-coordinate of Cartesian approximated palm point,
Y_{2,i} & Y_{1,i} is the Y-coordinate of Cartesian approximated palm point,
Rⱼ is the polar X-coordinate for the corresponding Cartesian coordinate,
Sⱼ is the polar Y-coordinate for the corresponding Cartesian coordinate.

In an embodiment, the feature extractor 234 may be configured to obtain a set of object characteristics associated with the target object based on the calculated set of distances. The set of object characteristics may be related to hand geometry and the associated characteristics. As a non-limiting example, the set of object characteristics may include thumb length, index finger length, middle finger length, ring finger length, pinkie length, thumb width, index finger width, middle finger width, ring finger width, pinkie width, thumb circle radius, and the like.

Based on the set of distances and the object characteristics, the feature extractor 234 may be configured to obtain an intermediate feature matrix (IFV_{hand}), as shown in FIG. 3. As an example, considering the set of object characteristics as given below in Table 1, the intermediate feature matrix may be calculated as shown in equation (6).

TABLE 1

| | |
|---|---|
| x₀₀:xₙ₀ | Thumb Length |
| x₀₁:xₙ₁ | Index Finger Length |
| x₀₂:xₙ₂ | Ring Finger Length |
| x₀₃:xₙ₃ | Index circle radius lower & |
| | Index circle radius upper |
| x₀₄:xₙ₄ | Middle circle radius lower & |
| | Middle circle radius upper |
| x₀₅:xₙ₅ | Thumb perimeter |
| x₀₆:xₙ₆ | Largest inscribed circle radius |

$${IFV}_{h a n d} = X = {[ \begin{matrix}{x}_{0} , {i}_{0} , {v}_{0} \\ {x}_{1} , {i}_{1} , {v}_{1} \\ {x}_{2} , {i}_{2} , {v}_{2} \\ . \\ . \\ {x}_{n - 1} , {i}_{n - 1} , {v}_{n - 1}\end{matrix} ]}_{n x m} \qquad ( 6 )$$

where each xᵢ is a (1xm) feature vector containing information associated with the hand of the target object based on the set of object characteristics, ‘i’ is index, and ‘v’ is visibility. The index refers to, for example, a formal numbering from 0 to n−1, where n=30. The visibility may initially be set to 1 for all the identified features of the hand, which may be validated by the feature validator 236. For non-visible features, the visibility may be updated to 0, as shown in an example representation below:

TABLE 2

| xₙ = [Features, Index, Visibility] | xₙ = [Distance Calculated, |
|---|---|
| | Index, Visibility] |
| x₀ = [Thumb Length, 1, 1] | x₀ = [0.655, 1, 1] |
| x₁ = [Index Finger Length, 2, 0] | x₁ = [0.187, 2, 0] |
| x₂ = [Ring Finger Length, 3, 1] | x₂ = [0.15, 3, 1] |
| x₃ = [Index Circle Radius Lower, | x₃ = [0.73, 4, 1] |
| 4, 1] | |

The feature validator 236 may be configured to obtain the one or more feature vectors, or hand feature vector, associated with the target object based on the one or more visible features. The feature validator 236 may take into consideration the intermediate feature matrix (IFV_{hand}) so as to provide the one or more feature vectors as an output. The feature validator 236 may be configured to obtain a visible feature matrix and a non-visible feature matrix from the intermediate feature matrix. That is, the intermediate feature matrix may be split into two feature vectors, namely, F_visible & F_ (non-visible). The feature vectors F_visible & F_ (non-visible) may be determined based on visible and non-visible features of the hand of the target object.

The feature validator 236 may further be configured to estimate corresponding visibility parameters for each feature of the visible feature matrix and the non-visible feature matrix. The feature validator 236 may further be configured to obtain the final feature vector based on the estimated corresponding visibility parameters. The final feature vector corresponds to the one or more feature vectors associated with the target object and is indicative of the one or more visible features.

In an embodiment, the visibility parameters may be determined based on a second trained mathematical model, the plurality of feature points, and one or more additional objects associated with the received image 101. The one or more additional objects may correspond to hands of the one or more users other than the target object within the received image 101. In an embodiment, the second trained mathematical model may be a CNN which may enable determination of probability of feature visibility for each feature associated with the hand of the target object. In an embodiment, the second trained mathematical model may be stored in a database, such as the dynamic validator 204D.

The second mathematical model may be trained based on relevant inputs and outputs provided to the second mathematical model. A dataset including multiple images of reference hands may be used as input. Further, visible and non-visible states associated with the features of the hands may be provided as output. As an example, from the dataset, a reference image (say, xₜᵣₐᵢₙ) may be provided as input to the first mathematical model and an output class (Sᵢ, 1≤i≤2) corresponding to the reference image may be provided as output so as to train the second mathematical model. In an embodiment, Sᵢ may include S₁ and S₂ where S₁ may refer to an ideal condition of the visibility of features from a given set of feature points and S₂ may refer to a non-ideal condition where the feature of a given hand closely relates with the feature of some other hand. That is, S₁ indicates that a particular feature is visible from the given set of feature points and S₂ indicates the particular feature is not visible from the given set of feature points. The probabilities of the states S₁ and S₂ may be determined by the second mathematical model based on the dataset.

In an embodiment where the probability of S₁ is less than S₂, the feature validator 236 may be configured to generate a first feedback based on the estimated visibility parameters. The first feedback may enable re-generation of the plurality of feature points and the intermediate feature matrix by the point approximator 232 and the feature extractor 234 respectively, based on the first feedback as shown in FIG. 3. The first feedback leads to less visible feature points being discarded and most visible feature points are extracted from the ROI, i.e., the hand of the target object.

In an embodiment, the final feature vector may be obtained based on the re-obtained plurality of feature points and the re-obtained intermediate feature matrix. In an embodiment, multiple iterations may be carried out to process the intermediate feature matrix in order to obtain the final feature vector.

In an embodiment, the probabilities of states S₁ and S₂ may be determined based on a binary logistic regression model, which may predict probability of an event based on the equation (7) below:

$$ln ( \frac{P}{1 - P} ) = {β}_{0} + {β}_{1} {X}_{1} + {β}_{2} {X}_{2} + … \qquad ( 7 )$$

where P refers to probability of event, β refers to regression coefficients, and X refers to independent variable values (in the present example, information associated with various features of the hand). Solving for the probability equation results in equation (8) below:

$$Probability of event = P = \frac{1}{1 + {e}^{- ( {β}_{0} + {β}_{1} {X}_{1} + {β}_{2} {X}_{2} + … )}} \qquad ( 8 )$$

Accordingly, probability P would be the probability of state S₁, and odds will be the probability of state S₂, i.e.,

$$odds = \frac{P}{1 - P} .$$

In an embodiment where the probability of S₁ is greater than S₂, the particular feature is added to an observable feature vector and where the probability of S₁ is less than S₂, the particular feature is added to a non-observable feature vector. For example, considering the intermediate feature matrix X=IFV_{hand} as shown in FIG. 4B, in a first iteration (k=1) depicted by 408A, a set-1 of observable feature and a set-1 of non-observable features may be generated. Further, based on the dataset of hands, a 1^{st} unique feature vector may be generated. Further, in the next iteration (k>1) depicted by 408B, based on the first feedback, a set-2 of observable features and a set-2 of non-observable features may be determined, leading to a 2^{nd} unique feature vector generation. Similarly, multiple iterations may be carried out based on the first feedback. Further, as depicted by 408C, in case a n^{th} unique feature vector in iteration (i) having values matching those of n−1^{th} feature vector in iteration (i−1) is detected, the n^{th} feature vector may be determined as the final feature vector, which corresponds to the one or more feature vectors associated with the target object.

As described above, the one or more feature vectors (hand feature vector) associated with the target object are obtained based on the identified ROI. Further, based on the identified ROI and the obtained image 101, a traversal path estimate may be obtained. In an embodiment, a session mapping module may be provided which generates a session key 204E associated with a particular user session. The session mapping module may be configured to generate a random unique key associated with the target object. As an example, if a user ‘U1’ is using an application say ‘A1’, a key ‘K1’ is generated. The key ‘K1’ is indicative of mapping of the user ‘U1’ to the application ‘A1’ so that a traversal path estimate is generated for the user ‘U1’. As shown in FIG. 3, the object path module 240 may be configured to, for example, determine the traversal path estimate which is indicative of a region of movement of the target object, in an example, the hand of the target object. Further, as shown in FIG. 2D and FIG. 3, the object path module 240 may further include a grid generator module 242, a grid adjustment module 244, and a blueprint generator module 246.

The grid generator module 242 may be configured to, for example, generate a grid map (GMap) corresponding to the identified ROI. The grid map may be formed of a plurality of grids. In an embodiment, the size of the generated grid map may be equal to a size of the identified ROI. In an embodiment, a size of each grid within the grid map may correspond to a size of the identified ROI and the grid map may be scaled to a size of the obtained image 101 including the ROI.

FIG. 4C illustrates an example grip map 410 formed of the plurality of grids 412. The grid map 410 may have the dimensions H by W, as illustrated. Further, each grid 412 of the plurality of grids may have dimensions h by w, wherein h<H and w<W. The dimensions of each grid 412 may be same as dimensions of the ROI (ROI_{height} by ROI_{width}). The number n(g) of the plurality of grids and the area a(g) of each grid 412 may be determined based on equations (9)-(10) below:

$$n ( g ) = ( H + W ) / ( h + w ) \qquad ( 9 )$$

$$a ( g ) = {ROI}_{height} * {ROI}_{width} \qquad ( 10 )$$

The grid adjustment module 244 may be configured to, for example, superimpose the ROI including the target object on the generated grid map 410, thereby allowing determination of an optimal position of the ROI and maximizing presence scores of the hands. The blueprint generator module 246 may then be configured to, for example, generate the traversal path estimate based on the superimposed ROI.

In an embodiment, the ROI may be superimposed on the grid map 410 at a location (X_{coord}, Y_{coord}). The grid adjustment module 244 may be configured to adjust the grid map 410 based on second feedback received from the determination module 250, as shown in FIG. 3. The second feedback may be indicative of an angle of orientation of the grid map 410. The angle of orientation may be used to laterally adjust the grids 412 of the grid map 410 based on known coordinates of the grids 412. Referring to FIG. 4D, the grid adjustment module 244 may adjust the grid map 410 based on the angle of orientation. In an example, the adjustment of the grids, say i^{th} grid, may be carried out by the grid adjustment module 244 based on the equation (11) below:

$$( {X}_{2} , {Y}_{2} ) = ( {X}_{1} + ( H * cos ( θ ) ) , {Y}_{1} + ( W * sin ( θ ) ) ) \qquad ( 11 )$$

where:
X₂, Y₂ are the new translation coordinates,
X₁, Y₁ are the known coordinates of the grid i,
H is the height of the grid i,
W is the width of the grid i,
θ is the angle of orientation.

As described above, the blueprint generator module 246 may be configured to, for example, obtain the traversal path estimate based on the superimposed ROI. The blueprint generator module 246 may further be configured to obtain a blueprint associated with the traversal path estimate based on the adjusted grip map. The blueprint may be proportioned with respect to the adjusted grip map in one or more dimensions. Further, the blueprint generator module 246 may be configured to obtain the traversal path estimate based on the obtained blueprint and the adjusted grid map. FIG. 4E illustrates the obtained traversal path estimate 414 in accordance with an embodiment of the disclosure.

In an embodiment, the traversal path estimate may be obtained based on the equation (12)-(14) in which k, i, j represent iteration numbers:

$$if k = 0 , traversal path estimate = ROI \qquad ( 12 )$$

$$( 13 )$$

$$if i < W , traversal path estimate = traversal path estimate + Grid Map [ i ]$$

$$( 14 )$$

$$if i < H , traversal path estimate = traversal path estimate + Grid Map [ i ]$$

The traversal path estimate allows estimation of position of hands by tracking the movements thereof. Based on the traversal path estimate, the mapped hand may be quickly detected within the traversal path estimated rather than within the complete image 101. Computation time and resources are thus saved and chances of false detection are significantly reduced. Further, with the adjustment of the grids based on angle of orientation, the number of false hands detected are reduced and probability of finding the mapped hand is increased.

Once the traversal path estimate and the one or more feature vectors are obtained, the determination module 250 may be configured to identify, the gesture associated with the target object to be one of a false gesture or a real gesture. That is, the determination module 250 may identify whether a gesture made by hand of the target object is a false or a real gesture. As shown in FIG. 2E and FIG. 3, the determination module 250 may include a dynamic vector module 252, a divergence module 254, a similarity loss module 256, and fine-tuning module 258.

The dynamic vector module 252 may be configured to, for example, obtain additional feature vectors for each object present in the region of the traversal path estimate. The objects present in the traversal path estimate may correspond to hands of users other than the target object or the hands of the target object. The additional feature vector may be generated by generating corresponding feature points, intermediate feature vectors, and final feature vectors in the manner as described above with reference to the feature vector module 230.

The divergence module 254 may be configured to, for example, compare the additional feature vectors with the obtained one or more feature vectors so as to evaluate a differentiation score (D). That is, the divergence module 254 may be configured to obtain a differentiation score associated with the target object based on the comparison of the additional feature vectors with the determined one or more feature vectors. In an embodiment, the differentiation score may be obtained based on equation (15) which considers the distance between the feature vectors, deviation angle between the feature vectors, and previous iterations' result for generating the differentiation score:

$${d 〚 ( x 〛}_{1} , {x}_{2} ) = {\sum }_{i = 0}^{i = C . {S}_{max}} ( Y * {D}^{2} ) tan φ + ( 1 - Y ) ( 1 - tan φ ) * max ( Y - D , 0 ) - {K}_{i - 1} \qquad ( 15 )$$

C. Sₘₐₓ maximum change in slope,
Y=label of image
Dₜ=distance of feature vectors x₁, x₂
Φ=deviation angle of feature vectors x₁, x₂
K=differentiation score of previous detection.

In an embodiment, the divergence module 254 may be configured to generate the second feedback based on the differentiation score. The second feedback may be sent to the grid adjustment module 244 so as to adjust the traversal path estimate, as described above.

The divergence module 254 may be further configured to compare the obtained differentiation score with a pre-determined threshold (T). As shown in FIG. 3, upon determining that the differentiation score is less than pre-determined threshold, the divergence module 254 may identify the gesture associated with the target object to be a real gesture. Further, upon determining that the differentiation score is greater than pre-determined threshold, the divergence module 254 may identify the gesture associated with the target object to be the false gesture.

In an embodiment, the similarity loss module 256 may be configured to obtain a similarity loss value associated with the target object and the additional object based on the differentiation score. In obtaining the similarity loss value, a set of distances associated with the one or more feature vectors may be considered by the similarity loss module 256. In an embodiment, the similarity loss value may be obtained for the target object and the additional objects by the similarity loss module 256 based on equation (16):

$$( 16 )$$

$$s 〚 ( x 〛 \_ 1 , x\_ 2 ) = {\sum }_{-} {( i = 0 )}^{⋀} ( i = N ) 〚 [ Y\_i * log ( D\_i ) + ( 1 - Y\_i ) * log ( 1 - D\_j ) - K 〛$$

where:
N=number of hands detected,
Y=label of image
Dₜ=distance of feature vectors x₁, x₂
K=differentiation score of previous detection.

In an embodiment, feedback may be generated based on the similarity loss module 256 for the first mathematical model that generates the plurality of feature points. The fine-tuning module 258 may be configured to facilitate updating the weights of the first mathematical model based on the similarity loss value. In an example, the weights of the first mathematical model may be fine-tuned by feeding error rate (i.e., similarity loss) of forward propagation backwards through the layers of the first mathematical model. Fine tuning of the first mathematic model facilitates low error lates and reliable inferences.

In an embodiment, error ∂L/∂z in a last layer of the first mathematical model may be computed and back propagated through all the layers of the first mathematical model.

Accordingly, the determination module 250 may allow identification of the target object from multiple objects, in that, the traversal path estimate is adjusted to maximize the probability of finding the target object. Further, differentiation factors between the target object and other objects can be determined based on analyzing the corresponding feature vectors.

Once it is determined whether the gesture associated with the target object is a real gesture or a false gesture, the output module 260 may be configured to trigger a response based on the determined gesture being the false gesture or the real gesture, as shown in of FIG. 3. In an embodiment, when the gesture is identified as a false gesture, the output module 260 may be configured to display a notification on the display unit of the user device 120, the notification being indicative of the gesture being a false gesture. In an embodiment, when the gesture is identified as a false gesture, the output module 260 may be configured to discard the gesture and no action may be taken for the gesture.

In an embodiment, when the gesture is identified as a real gesture, the output module 260 may be configured to identify a plurality of three-dimensional (3D) landmarks associated with the target object. In an embodiment, the plurality of 3D landmarks may be identified based on a third mathematical model, such as a CNN, in conjunction with the hand detection model 204C. The CNN may be trained to identify specific hand landmarks within the ROI of the hand. In an embodiment, the plurality of 3D landmarks may include a set of 21 landmarks.

Further, the output module 260 may be configured to display the plurality of 3D landmarks on the display unit of the user device 120. Furthermore, an action associated with the real gesture may be performed on the display unit. The correlation of gestures and action to be performed in response to the gestures may be pre-defined and stored in a database. Accordingly, the gesture may be detected and the corresponding action may be performed. In case the gesture is a false gesture, as described above, no action may be performed in response to the false gesture or a notification indicative of the false gesture may be displayed.

In an embodiment, the feature vector module 230 may include a unique identifier generator module configured to generate a unique identifier corresponding to the hand of the target object and corresponding to hands of additional objects. As will be appreciated, each hand is unique and the corresponding identifier of the hand would consequently be a unique identifier. Once the unique identifier of hands of the target object and additional objects are generated, the unique identifiers of the hands present in the traversal path estimate may be compared to a unique identifier stored in the memory 204, which may correspond to the target object. As a result, processing of unwanted hands may be eliminated. In an embodiment, the unique identifier for a hand may be a function of (w1F1, w2F2, w3F3 . . . wnFn) in which F1, F2, . . . Fn correspond to extracted unique features and w1, w2, . . . wn correspond to weighted impact of each feature.

In an embodiment, the feature vector module 230 may include a landmarking module and a mixer module. The landmarking module may be configured to, for example, extract two-dimensional (2D) landmarks points of objects visible in the image. Based on the landmark points, an outline of the objects visible in the image may be determined. The mixer module may be configured to, for example, facilitate differentiating between the target object and additional objects. In an example, the mixer module may be configured to generate feature vectors embedded with 2D landmark points associated with the target object.

FIG. 5A illustrates an example process flow of a method 500 for identifying a gesture associated with a target object, according to an embodiment of the present disclosure. In an embodiment, the steps of the method 500 may be performed by the system 110, for example, by the processor 202 of the system 110 in conjunction with the plurality of modules 201 and the memory 204, which may be integrated within the user device 120 or provided separately and operatively coupled thereto.

At step 502, the method 500 includes receiving an image 101 associated with the target object.

At step 504, the method 500 includes identifying a region of interest (ROI) within the image 101. The ROI is associated with the target object. In an embodiment, to identify the ROI associated with the target object, the method 504 may include steps 504A-504C as illustrated in FIG. 5B. At step 504A, the method 504 may include obtaining a plurality of bounding boxes corresponding to the target object. At step 504B, the method 504 may include identifying the target object within the image 101 based on the plurality of bounding boxes. At step 504C, the method 504 may include identifying the ROI corresponding to the identified target object.

At step 506, the method 500 may include obtaining one or more feature vectors associated with the target object based on the identified ROI. In an embodiment, to obtain the one or more feature vectors associated with the target object, the method 506 may include steps 506A-506C as illustrated in FIG. 5C. At step 506A, the method 506 may include obtaining a plurality of feature points associated with the target object. At step 506B, the method 506 may include identifying one or more visible features associated with the target object based on the obtained plurality of feature points. At step 506C, the method 506 may include obtaining the one or more feature vectors associated with the target object based on the one or more visible features.

At step 508, the method 500 may include obtaining a traversal path estimate based on the obtained image 101 and the identified ROI. The traversal path estimate may be indicative of a region of movement of the target object. In an embodiment, to obtain the traversal path estimate, the method 508 may include steps 508A-508C as illustrated in FIG. 5D. At step 508A, the method 508 may include generating a grid map corresponding to the identified ROI, wherein a size of each grid within the grid map corresponds to a size of the identified ROI, and wherein the grid map is scaled to a size of the obtained image. At step 508B, the method 508 may include superimposing the ROI including the target object on the generated grid map. At step 508C, the method 508 may include obtaining the traversal path estimate based on the superimposed ROI.

At step 510, the method 500 may include identifying, based on the one or more feature vectors and the generated traversal path estimate, the gesture associated with the target object to be one of a false gesture or a real gesture. In an embodiment, to identify the gesture associated with the target object to be one of a false gesture or a real gesture, the method 510 may include steps 510A-510F as illustrated in FIG. 5E.

At step 510A, the method 510 may include obtaining, for each object present in a region of the traversal path estimate, additional feature vectors corresponding to the each present object, wherein the each present object includes one or more of the target object or additional objects. At step 510B, the method 510 may include comparing the additional feature vectors with the obtained one or more feature vectors. At step 510C, the method 510 may include obtaining a differentiation score associated with the target object based on the comparison of the additional feature vectors with the obtained one or more feature vectors. At step 510D, the method 510 may include comparing the obtained differentiation score with a pre-determined (or specified) threshold. At step 510E, the method 510 may include upon determining that the differentiation score is less than pre-determined threshold, identifying the gesture associated with the target object to be a real gesture. At step 510F, the method 510 may include upon determining that the differentiation score is greater than pre-determined threshold, identifying the gesture associated with the target object to be a false gesture.

The method 500 may include triggering a response based on the determined gesture being a false gesture or a real gesture.

While the above discussed steps in FIGS. 5A-5E are shown and described in a sequence, the steps may occur in variations to the sequence in accordance with various embodiments. Further, a detailed description related to the various steps of FIGS. 5A-5E is already covered in the description related to FIGS. 1-4E and is not repeated here for the sake of brevity.

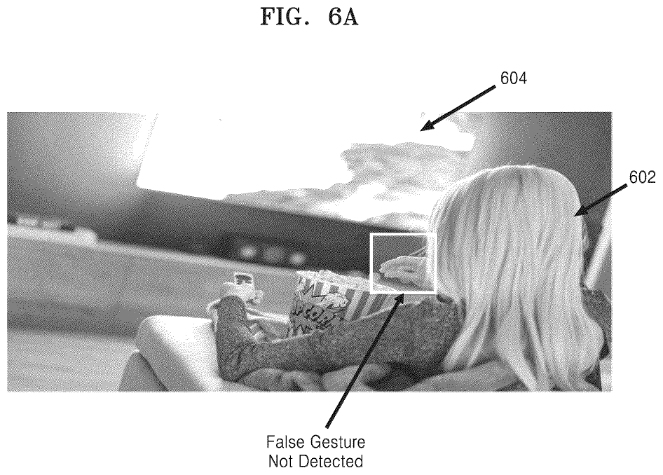

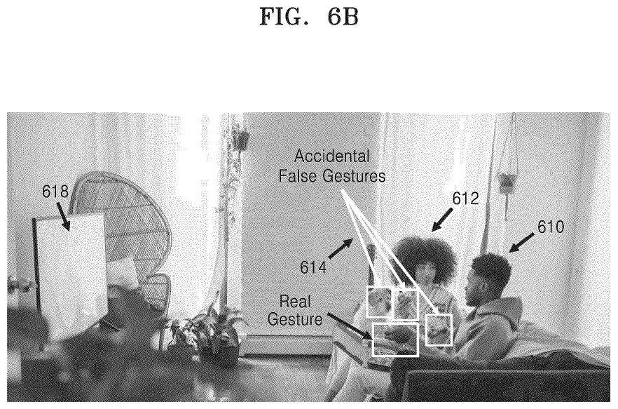

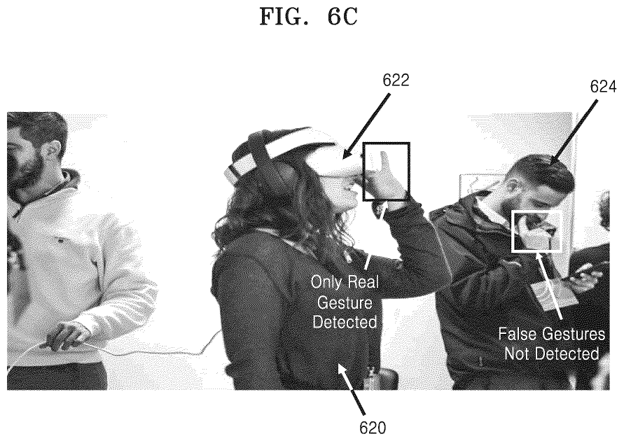

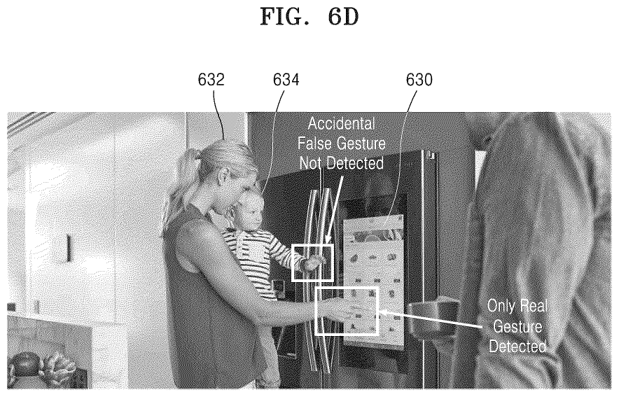

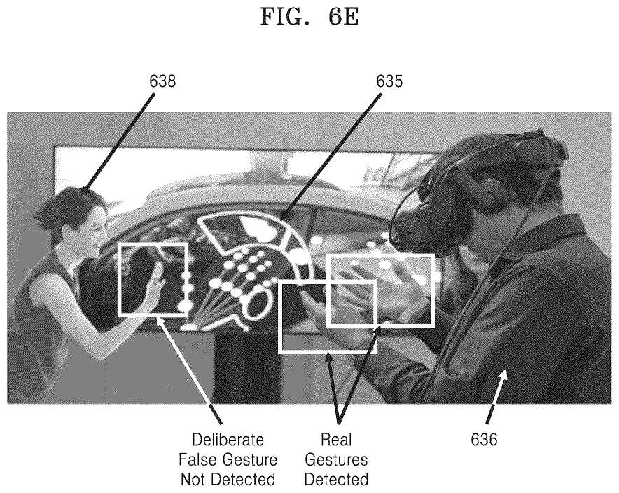

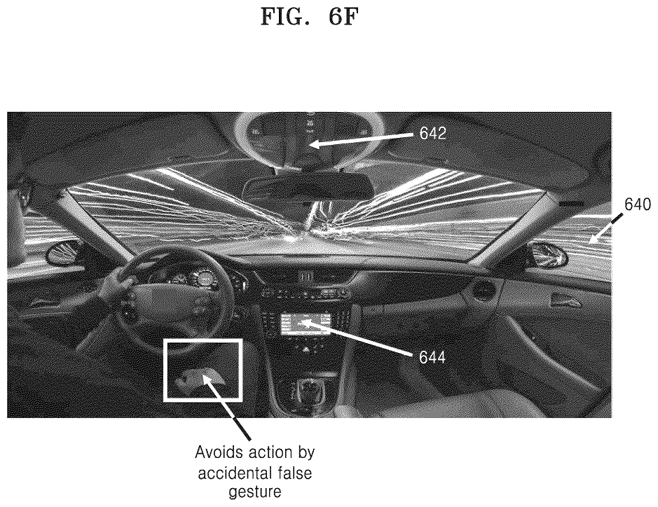

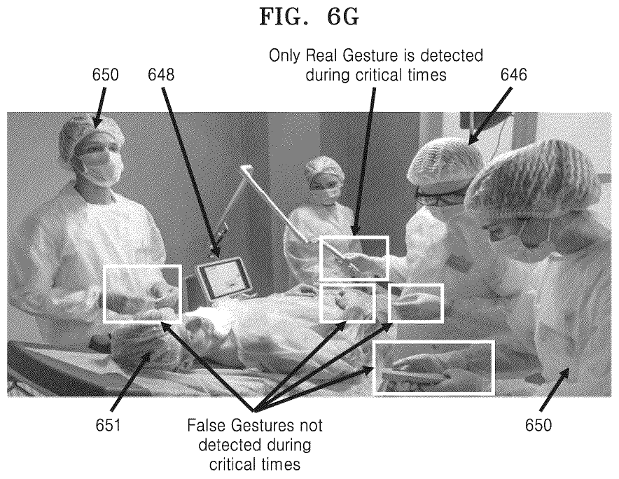

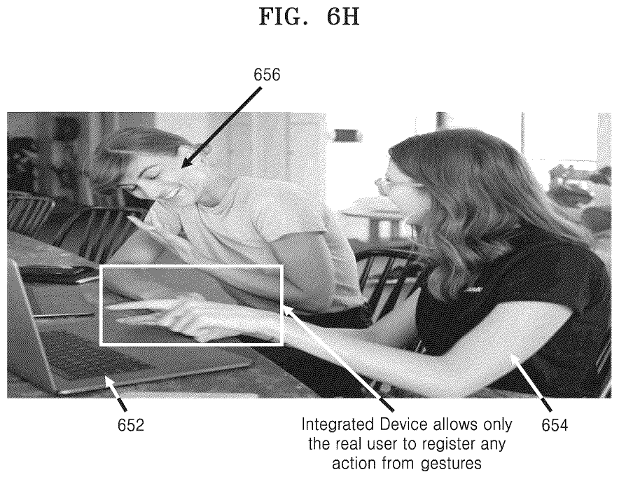

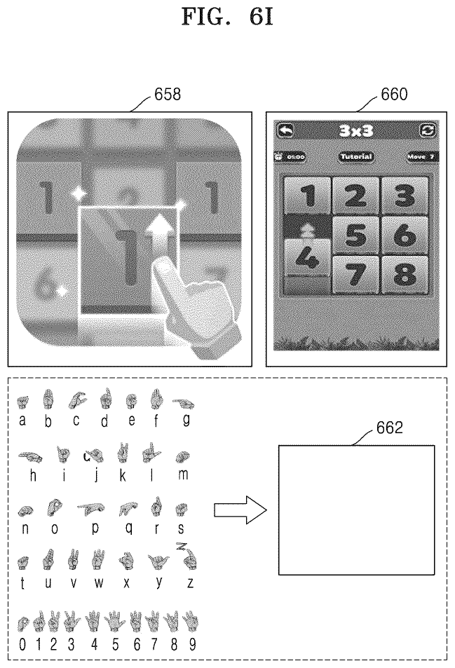

FIGS. 6A, 6B, 6C, 6D, 6E, 6F, 6G, 6H, 6I, and 6J illustrate various example usage scenarios of a method and system for identifying a gesture associated with a target object, according to an embodiment of the present disclosure.

FIG. 6A illustrates a user 602 in front of a smart television 604 and watching content on the television 604. The user 602 may be doing an activity, such as eating food by using one of the hands. However, with the system and method as disclosed herein, the movement of hand of the user 602 for doing the activity is not detected as a gesture, even though the movement may be similar to a pre-defined gesture. Any action associated with the accidental movement in a similar manner to a gesture may be prevented.

FIG. 6B illustrates multiple entities 610, 612, and 614 within the line of sight of a camera associated with a smart device 618, such as a smart TV. From among the multiple entities, the entity 610 may be a main user and may provide a real gesture for controlling the smart device 618. Gestures from the entities 612 and 614 may be accidental false gestures. The system and method disclosed herein accurately detect gestures from the entity 610 while discarding the gestures from the entities 612 and 614. Thus, gestures from different entities are distinguished efficiently.

FIG. 6C illustrates a user 620 using a VR device 622 for viewing contents in virtual reality. The user may provide one or more commands via their hands, which is a real gesture. As seen in FIG. 6C, another user 624 is present within a field of view of a camera of the VR device 622, however, any accidental or deliberate gestures from the user 624 are considered by the disclosed system and method as false gestures. Hence, no action is taken in response to the gestures from the user 624.

FIG. 6D illustrates a refrigerator integrated with an interactive device 630 configured to receive commands based on gestures from users. A first user 632 and a second user 634 may be within the field of view of a camera associated with the device 630. The first user 632 may be providing real gestures for controlling the device 630, however, the second user 634 may be providing false gestures by means of accidental hand movements. The system and method of the present disclosure eliminates or reduces any action based on the accidental gestures by the second user 634 and only detects and acts on gestures from the first user 632.

FIG. 6E illustrates a gesture gaming device 635 being used by a first user 636. The first user 636 may be controlling the device 635 by means of hand movement, i.e., by gestures. A second user 638 may be interacting with the first user 636, or any other different user, using hand movements which may be deliberately or accidentally similar to pre-defined gestures. However, the hand movements of the second user 638 are not detected as real gestures and no action is performed based on the hand movements of the second user 638. As a result, any unintentional gesture detection during gameplay is eliminated or reduced, thereby enhancing user experience.

FIG. 6F illustrates a vehicle 640 integrated with a camera 642 and an infotainment system 644. A user may control the infotainment system 644 by means of gestures that are detected by the camera 642. However, any accidental hand movements are not detected as gestures and no action is performed in response to the false gestures.

FIG. 6G illustrates a device for medical applications being used by a doctor 646 during complex surgeries and for medical imaging. The doctor 646 may provide commands via gestures within the field of view of a camera 648 associated with the device. The doctor 646 may provide commands by using one of the hands, and these gestures from the doctor 646 may be considered as real gestures and corresponding actions may be performed. However, any false gestures from other hand of the doctor 646, from assistants 650, and/or from patient 651 are not detected as a real gesture and any accidental action is avoided during critical times.

FIG. 6H illustrates a device 652 capable of performing actions in response to gestures. A user 654 associated with the device 652 may provide commands to the device 652 via gestures. In case there is another user 656 within a field of view of the device 652, any gesture from the other user 656 is classified as a false gesture. That is, gestures from the user 654 are only detected and acted upon to perform related functions.

FIG. 6I illustrates user interfaces 658, 660 associated with gesture based Extended Reality (XR) games and interface 662 associated with Input Method Editors (IME). When a user is interacting with the XR games or when a user is using IME, the user experience is enhanced since detection of any false and unintended hand gestures is eliminated or reduced. The system and method of the present disclosure thus increase user experience in gesture-based games and IME.

The present disclosure provides for various technical advancements based on features discussed above. For example, the disclosure may allow identification of false gestures during user interactions with the devices or with each other. Natural user interaction by use of hand gestures, which may arise due to accidental or deliberate actions, are distinguished efficiently and accurately as real gestures or false gestures. Minute differentiation factors of the hands of multiple users are evaluated and visible features are extracted by analyzing the visible features of the hand. Any actions for the accidental false and deliberate false gestures are eliminated or reduced. The methods and systems of the present disclosure for false gesture detections can be applied to numerous fields such as, but not limited to, AR/VR Gaming, Metaverse, Fitness Applications, Automotive Devices, and the like.

While specific language has been used to describe the present subject matter, such language is not intended to be limiting. Various working modifications may be made to the method in order to implement the disclosure. The drawings and the foregoing description provide example embodiments. Those skilled in the art will appreciate that one or more of the described elements may well be combined into a single functional element. Alternatively, certain elements may be split into multiple functional elements. Elements from one embodiment may be added to another embodiment.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

According to an embodiment of the disclosure, a method for identifying a gesture associated with a target object may include triggering a response based on the gesture being obtained to be a false gesture or a real gesture.

According to an embodiment of the disclosure, a method for identifying the ROI associated with the target object may include obtaining a plurality of bounding boxes corresponding to the target object. According to an embodiment of the disclosure, a method for identifying the ROI associated with the target object may include identifying the target object within the image based on the plurality of bounding boxes. According to an embodiment of the disclosure, a method for identifying the ROI associated with the target object may include identifying the ROI corresponding to the identified target object.

According to an embodiment of the disclosure, a method for obtaining the one or more feature vectors associated with the target object may include obtaining a plurality of feature points associated with the target object. According to an embodiment of the disclosure, a method for obtaining the one or more feature vectors associated with the target object may include identifying one or more visible features associated with the target object based on the obtained plurality of feature points. According to an embodiment of the disclosure, a method for obtaining the one or more feature vectors associated with the target object may include obtaining the one or more feature vectors associated with the target object based on the one or more visible feature.

According to an embodiment of the disclosure, a method for obtaining the plurality of feature points associated with the target object may include identifying edges of the target object to generate an edge detected object based on an edge detection model. According to an embodiment of the disclosure, a method for obtaining the plurality of feature points associated with the target object may include obtaining the plurality of feature points from the edge detected object based on a first trained mathematical model.

According to an embodiment of the disclosure, a method for identifying the one or more visible features associated with the target object may include obtaining a set of distances among the plurality of feature points associated with the target object. According to an embodiment of the disclosure, a method for identifying the one or more visible features associated with the target object may include identifying a set of object characteristics associated with the target object based on the obtained set of distances. According to an embodiment of the disclosure, a method for identifying the one or more visible features associated with the target object may include obtaining an intermediate feature matrix based on the set of distances and the object characteristics.

According to an embodiment of the disclosure, a method for obtaining the one or more feature vectors associated with the target object may include obtaining, from the intermediate feature matrix, a visible feature matrix and a non-visible feature matrix. According to an embodiment of the disclosure, a method for obtaining the one or more feature vectors associated with the target object may include estimating, based on a second trained mathematical model, the plurality of feature points, and one or more additional objects associated with the obtained image, corresponding visibility parameters for each feature of the visible feature matrix and the non-visible feature matrix. According to an embodiment of the disclosure, a method for obtaining the one or more feature vectors associated with the target object may include obtaining a final feature vector based on the estimated corresponding visibility parameters, the final feature vector corresponding to the one or more feature vectors associated with the target object, wherein the final feature vector is indicative of the one or more visible features.

According to an embodiment of the disclosure, a method for obtaining the final feature vector may include generating a first feedback based on the estimated visibility parameters. According to an embodiment of the disclosure, a method for obtaining the final feature vector may include re-obtaining the plurality of feature points and the intermediate feature matrix based on the first feedback. According to an embodiment of the disclosure, a method for obtaining the final feature vector may include obtaining the final feature vector based on the re-obtained plurality of feature points and the re-obtained intermediate feature matrix.

According to an embodiment of the disclosure, a method for obtaining the traversal path estimate based on the received image and the identified ROI may include generating a grid map corresponding to the identified ROI, wherein a size of each grid within the grid map corresponds to a size of the identified ROI, and wherein the grid map is scaled to a size of the received image. According to an embodiment of the disclosure, a method for obtaining the traversal path estimate based on the received image and the identified ROI may include superimposing the ROI comprising the target object on the generated grid map. According to an embodiment of the disclosure, a method for obtaining the traversal path estimate based on the received image and the identified ROI may include obtaining the traversal path estimate based on the superimposed ROI.

According to an embodiment of the disclosure, a method for obtaining the traversal path estimate further may include adjusting the grid map based on a second feedback, wherein the second feedback is indicative of an angle of orientation of the grid map. According to an embodiment of the disclosure, a method for obtaining the traversal path estimate further may include obtaining a blueprint associated with the traversal path estimate based on the adjusted grip map, wherein the blueprint is proportioned with respect to the adjusted grip map in one or more dimensions. According to an embodiment of the disclosure, a method for obtaining the traversal path estimate further may include obtaining the traversal path estimate based on the determined blueprint and the adjusted grid map.

According to an embodiment of the disclosure, a method for identifying whether the gesture associated with the target object is one of a false gesture or a real gesture may include obtaining, for each object present in a region of the traversal path estimate, additional feature vectors corresponding to the each present object, wherein the each present object includes one or more of the target object or additional objects. According to an embodiment of the disclosure, a method for identifying whether the gesture associated with the target object is one of a false gesture or a real gesture may include comparing the additional feature vectors with the obtained one or more feature vectors. According to an embodiment of the disclosure, a method for identifying whether the gesture associated with the target object is one of a false gesture or a real gesture may include obtaining a differentiation score associated with the target object based on the comparison of the additional feature vectors with the obtained one or more feature vectors. According to an embodiment of the disclosure, a method for identifying whether the gesture associated with the target object is one of a false gesture or a real gesture may include comparing the obtained differentiation score with a pre-determined threshold. According to an embodiment of the disclosure, a method for identifying whether the gesture associated with the target object is one of a false gesture or a real gesture may include upon determining that the differentiation score is less than pre-determined threshold, identifying the gesture associated with the target object to be a real gesture. According to an embodiment of the disclosure, a method for identifying whether the gesture associated with the target object is one of a false gesture or a real gesture may include upon determining that the differentiation score is greater than pre-determined threshold, identifying the gesture associated with the target object to be a false gesture.

According to an embodiment of the disclosure, a method for identifying whether the gesture associated with the target object is one of a false gesture or a real gesture may include obtaining, based on the differentiation score and a set of distances associated with the one or more feature vectors, a similarity loss value associated with the target object and the additional objects. According to an embodiment of the disclosure, a method for identifying whether the gesture associated with the target object is one of a false gesture or a real gesture may include updating a mathematical model based on the obtained similarity loss value, wherein the mathematical model is adapted to generate a plurality of feature points associated with the target object, wherein updating the mathematical model comprises updating numerical weights associated with the mathematical model.

According to an embodiment of the disclosure, a method for triggering the response based on the gesture being determined to be a false gesture or a real gesture may include, when the gesture is identified as the real gesture, identifying a plurality of three-dimensional (3D) landmarks associated with the target object. According to an embodiment of the disclosure, a method for triggering the response based on the gesture being determined to be a false gesture or a real gesture may include, when the gesture is identified as the real gesture, displaying the plurality of 3D landmarks on a display unit (122). According to an embodiment of the disclosure, a method for triggering the response based on the gesture being determined to be a false gesture or a real gesture may include, when the gesture is identified as the real gesture, performing an action associated with the real gesture object on the display unit. According to an embodiment of the disclosure, a method for triggering the response based on the gesture being determined to be a false gesture or a real gesture may include, when the gesture is identified as the false gesture, displaying a notification on the display unit (122), the notification being indicative of the gesture being the false gesture. According to an embodiment of the disclosure, a method for triggering the response based on the gesture being determined to be a false gesture or a real gesture may include, when the gesture is identified as the false gesture, discarding the gesture.

According to an embodiment of the present disclosure, at least one processor may be configured to trigger a response based on the gesture being determined to be the false gesture or the real gesture.

According to an embodiment of the present disclosure, at least one processor may be configured to obtain a plurality of bounding boxes corresponding to the target object. According to an embodiment of the present disclosure, at least one processor may be configured to identify the target object within the image based on the plurality of bounding boxes. According to an embodiment of the present disclosure, at least one processor may be configured to identify the ROI corresponding to the detected target object.

According to an embodiment of the present disclosure, at least one processor may be configured to obtain a plurality of feature points associated with the target object. According to an embodiment of the present disclosure, at least one processor may be configured to identify one or more visible features associated with the target object based on the obtained plurality of feature points. According to an embodiment of the present disclosure, at least one processor may be configured to obtain the one or more feature vectors associated with the target object based on the one or more visible features. According to an embodiment of the present disclosure, at least one processor may be configured to identify edges of the target object to generate an edge detected object based on an edge detection model. According to an embodiment of the present disclosure, at least one processor may be configured to obtain the plurality of feature points from the edge detected object based on a first trained mathematical model. According to an embodiment of the present disclosure, at least one processor may be configured to calculate a set of distances among the plurality of feature points associated with the target object. According to an embodiment of the present disclosure, at least one processor may be configured to determine a set of object characteristics associated with the target object based on the calculated set of distances. According to an embodiment of the present disclosure, at least one processor may be configured to generate an intermediate feature matrix based on the set of distances and the object characteristics. According to an embodiment of the present disclosure, at least one processor may be configured to determine, from the intermediate feature matrix, a visible feature matrix and a non-visible feature matrix. According to an embodiment of the present disclosure, at least one processor may be configured to estimate, based on a second trained mathematical model, the plurality of feature points, and one or more additional objects associated with the received image, corresponding visibility parameters for each feature of the visible feature matrix and the non-visible feature matrix. According to an embodiment of the present disclosure, at least one processor may be configured to generate a final feature vector based on the estimated corresponding visibility parameters, the final feature vector corresponding to the one or more feature vectors associated with the target object, wherein the final feature vector is indicative of the one or more visible features. According to an embodiment of the present disclosure, at least one processor may be configured to generate a first feedback based on the estimated visibility parameters. According to an embodiment of the present disclosure, at least one processor may be configured to re-generate the plurality of feature points (404, 406) and the intermediate feature matrix based on the first feedback. According to an embodiment of the present disclosure, at least one processor may be configured to generate the final feature vector based on the re-generated plurality of feature points and the re-generated intermediate feature matrix. According to an embodiment of the present disclosure, at least one processor may be configured to generate a grid map corresponding to the identified ROI, wherein a size of each grid within the grid map corresponds to a size of the identified ROI, and wherein the grid map is scaled to a size of the received image. According to an embodiment of the present disclosure, at least one processor may be configured to superimpose the ROI comprising the target object on the generated grid map. According to an embodiment of the present disclosure, at least one processor may be configured to obtain the traversal path estimate based on the superimposed ROI. According to an embodiment of the present disclosure, at least one processor may be configured to adjust the grid map based on a second feedback, wherein the second feedback is indicative of an angle of orientation of the grid map. According to an embodiment of the present disclosure, at least one processor may be configured to obtain a blueprint associated with the traversal path estimate based on the adjusted grip map, wherein the blueprint is proportioned with respect to the adjusted grip map in one or more dimensions. According to an embodiment of the present disclosure, at least one processor may be configured to obtain the traversal path estimate based on the obtained blueprint and the adjusted grid map. According to an embodiment of the present disclosure, at least one processor may be configured to obtain, for each object present in a region of the traversal path estimate, additional feature vectors corresponding to the each present object, wherein the each present object includes one or more of the target object or additional objects. According to an embodiment of the present disclosure, at least one processor may be configured to compare the additional feature vectors with the identified one or more feature vectors. According to an embodiment of the present disclosure, at least one processor may be configured to obtain a differentiation score associated with the target object based on the comparison of the additional feature vectors with the identified one or more feature vectors. According to an embodiment of the present disclosure, at least one processor may be configured to compare the obtained differentiation score with a pre-determined threshold. According to an embodiment of the present disclosure, at least one processor may be configured to upon a determination that the differentiation score is less than pre-determined threshold, identify the gesture associated with the target object to be a real gesture. According to an embodiment of the present disclosure, at least one processor may be configured to upon a determination that the differentiation score is greater than pre-determined threshold, identify the gesture associated with the target object to be a false gesture. According to an embodiment of the present disclosure, at least one processor may be configured to obtain, based on the differentiation score and a set of distances associated with the one or more feature vectors, a similarity loss value associated with the target object and the additional objects. According to an embodiment of the present disclosure, at least one processor may be configured to update a mathematical model based on the obtained similarity loss value, wherein the mathematical model is adapted to generate a plurality of feature points associated with the target object, wherein updating the mathematical model comprises updating numerical weights associated with the mathematical model. According to an embodiment of the present disclosure, at least one processor may be configured to, when the gesture is identified as the real gesture, identify a plurality of three-dimensional (3D) landmarks associated with the target object. According to an embodiment of the present disclosure, at least one processor may be configured to, when the gesture is identified as the real gesture, display the plurality of 3D landmarks on a display unit. According to an embodiment of the present disclosure, at least one processor may be configured to, when the gesture is identified as a false gesture, perform displaying a notification on the display unit, the notification being indicative of the gesture being the false gesture. According to an embodiment of the present disclosure, at least one processor may be configured to, when the gesture is identified as a false gesture, perform discarding the gesture.

According to an embodiment of the disclosure, above devices and methods may overcome at least some of the above-mentioned limitations that efficiently differentiate between the real and false gestures.

What is claimed is:

1. A method for identifying a gesture associated with a target object, the method comprising:
obtaining an image associated with the target object;
identifying a region of interest (ROI) within the image, the ROI being associated with the target object;
obtaining one or more feature vectors associated with the target object based on the identified ROI;
obtaining a traversal path estimate based on the obtained image and the identified ROI, the traversal path estimate being indicative of a region of movement of the target object;
identifying, based on the one or more feature vectors and the obtained traversal path estimate, whether the gesture associated with the target object is one of a false gesture or a real gesture.

2. The method as claimed in claim 1, wherein identifying the ROI associated with the target object comprises:
obtaining a plurality of bounding boxes corresponding to the target object;
identifying the target object within the image based on the plurality of bounding boxes; and
identifying the ROI corresponding to the identified target object.

3. The method as claimed in claim 1, wherein obtaining the one or more feature vectors associated with the target object comprises:
obtaining a plurality of feature points associated with the target object;
identifying one or more visible features associated with the target object based on the obtained plurality of feature points; and
obtaining the one or more feature vectors associated with the target object based on the one or more visible features.

4. The method as claimed in claim 3, wherein obtaining the plurality of feature points associated with the target object comprises:
identifying edges of the target object to generate an edge detected object based on an edge detection model; and
obtaining the plurality of feature points from the edge detected object based on a first trained mathematical model.

5. The method as claimed in claim 4, wherein identifying the one or more visible features associated with the target object comprises:
obtaining a set of distances among the plurality of feature points associated with the target object;
identifying a set of object characteristics associated with the target object based on the obtained set of distances; and
obtaining an intermediate feature matrix based on the set of distances and the object characteristics.

6. The method as claimed in claim 5, wherein obtaining the one or more feature vectors associated with the target object comprises:
obtaining, from the intermediate feature matrix, a visible feature matrix and a non-visible feature matrix;
estimating, based on a second trained mathematical model, the plurality of feature points, and one or more additional objects associated with the obtained image, corresponding visibility parameters for each feature of the visible feature matrix and the non-visible feature matrix; and
obtaining a final feature vector based on the estimated corresponding visibility parameters, the final feature vector corresponding to the one or more feature vectors associated with the target object, wherein the final feature vector is indicative of the one or more visible features.

7. The method as claimed in claim 6, wherein obtaining the final feature vector comprises:
generating a first feedback based on the estimated visibility parameters;
re-obtaining the plurality of feature points and the intermediate feature matrix based on the first feedback; and
obtaining the final feature vector based on the re-obtained plurality of feature points and the re-obtained intermediate feature matrix.

8. The method as claimed in claim 1, wherein obtaining the traversal path estimate based on the received image and the identified ROI comprises:
generating a grid map corresponding to the identified ROI, wherein a size of each grid within the grid map corresponds to a size of the identified ROI, and wherein the grid map is scaled to a size of the received image;
superimposing the ROI comprising the target object on the generated grid map; and
obtaining the traversal path estimate based on the superimposed ROI.

9. The method as claimed in claim 8, wherein obtaining the traversal path estimate further comprises:
adjusting the grid map based on a second feedback, wherein the second feedback is indicative of an angle of orientation of the grid map;
obtaining a blueprint associated with the traversal path estimate based on the adjusted grip map, wherein the blueprint is proportioned with respect to the adjusted grip map in one or more dimensions; and
obtaining the traversal path estimate based on the determined blueprint and the adjusted grid map.

10. The method as claimed in claim 1, wherein identifying whether the gesture associated with the target object is one of a false gesture or a real gesture comprises:
obtaining, for each object present in a region of the traversal path estimate, additional feature vectors corresponding to the each present object, wherein the each present object includes one or more of the target object or additional objects;
comparing the additional feature vectors with the obtained one or more feature vectors;
obtaining a differentiation score associated with the target object based on the comparison of the additional feature vectors with the obtained one or more feature vectors;
comparing the obtained differentiation score with a pre-determined threshold;
upon determining that the differentiation score is less than pre-determined threshold, identifying the gesture associated with the target object to be a real gesture; and
upon determining that the differentiation score is greater than pre-determined threshold, identifying the gesture associated with the target object to be a false gesture.

11. The method as claimed in claim 10, further comprising:
obtaining, based on the differentiation score and a set of distances associated with the one or more feature vectors, a similarity loss value associated with the target object and the additional objects; and
updating a mathematical model based on the obtained similarity loss value, wherein the mathematical model is adapted to generate a plurality of feature points associated with the target object,
wherein updating the mathematical model comprises updating numerical weights associated with the mathematical model.

12. An electronic device for identifying a gesture associated with a target object, the electronic device comprising:
a memory configured to store a plurality of modules in the form of programmable instructions;
at least one processor, comprising processing circuitry, communicatively coupled to the memory, the at least one processor being configured to, individually and/or collectively, control the system to perform operations comprising:
obtaining an image associated with the target object;
identifying a region of interest (ROI) within the image, the ROI being associated with the target object;
obtaining one or more feature vectors associated with the target object based on the identified ROI;
obtaining a traversal path estimate based on the received image and the identified ROI, the traversal path estimate being indicative of a region of movement of the target object;
identifying, based on the one or more feature vectors and the obtained traversal path estimate, whether the gesture associated with the target object is one of a false gesture or a real gesture.

13. The electronic device as claimed in claim 12, wherein at least one processor is configured to:
obtain a plurality of bounding boxes corresponding to the target object;
identify the target object within the image based on the plurality of bounding boxes; and
identify the ROI corresponding to the detected target object.

14. The electronic device as claimed in claim 12, wherein at least one processor is configured to:
obtain a plurality of feature points associated with the target object;
identify one or more visible features associated with the target object based on the obtained plurality of feature points; and
obtain the one or more feature vectors associated with the target object based on the one or more visible features.

15. The electronic device as claimed in claim 14, wherein at least one processor is configured to:
identify edges of the target object to generate an edge detected object based on an edge detection model; and
obtain the plurality of feature points from the edge detected object based on a first trained mathematical model.

16. The electronic device as claimed in claim 12, wherein at least one processor is configured to:
generate a grid map corresponding to the identified ROI, wherein a size of each grid within the grid map corresponds to a size of the identified ROI, and wherein the grid map is scaled to a size of the received image;
superimpose the ROI comprising the target object on the generated grid map; and
obtain the traversal path estimate based on the superimposed ROI.

17. The electronic device as claimed in claim 16, wherein at least one processor is configured to:
adjust the grid map based on a second feedback, wherein the second feedback is indicative of an angle of orientation of the grid map;
obtain a blueprint associated with the traversal path estimate based on the adjusted grip map, wherein the blueprint is proportioned with respect to the adjusted grip map in one or more dimensions; and
obtain the traversal path estimate based on the obtained blueprint and the adjusted grid map.

18. The electronic device as claimed in claim 12, wherein at least one processor is configured to:
obtain, for each object present in a region of the traversal path estimate, additional feature vectors corresponding to the each present object, wherein the each present object includes one or more of the target object or additional objects;
compare the additional feature vectors with the identified one or more feature vectors;
obtain a differentiation score associated with the target object based on the comparison of the additional feature vectors with the identified one or more feature vectors;
compare the obtained differentiation score with a pre-determined threshold;
upon a determination that the differentiation score is less than pre-determined threshold, identify the gesture associated with the target object to be a real gesture; and
upon a determination that the differentiation score is greater than pre-determined threshold, identify the gesture associated with the target object to be a false gesture.

19. The electronic device as claimed in claim 18, wherein at least one processor is configured to:
obtain, based on the differentiation score and a set of distances associated with the one or more feature vectors, a similarity loss value associated with the target object and the additional objects; and
update a mathematical model based on the obtained similarity loss value, wherein the mathematical model is adapted to generate a plurality of feature points associated with the target object,
wherein updating the mathematical model comprises updating numerical weights associated with the mathematical model.

20. A non-transitory computer-readable storage medium storing instructions that, when executed by at least one processor, cause the at least one processor to:
obtain an image associated with the target object;
identify a region of interest (ROI) within the image, the ROI being associated with the target object;
obtain one or more feature vectors associated with the target object based on the identified ROI;
obtain a traversal path estimate based on the received image and the identified ROI, the traversal path estimate being indicative of a region of movement of the target object;
identify, based on the one or more feature vectors and the obtained traversal path estimate, whether the gesture associated with the target object is one of a false gesture or a real gesture.
